(19) United States
(12) Patent Application Publication
(10) Pub. No.: US 2025/0350993 A1
(43) Pub. Date: Nov. 13, 2025

(54) COMMUNICATION QUALITY ESTIMATION SYSTEM, COMMUNICATION QUALITY ESTIMATION METHOD AND PROGRAM

(71) Applicant: NIPPON TELEGRAPH AND TELEPHONE CORPORATION, Tokyo (JP)

(72) Inventors: Kenichi KAWAMURA, Tokyo (JP); Naoki SHIBUYA, Tokyo (JP); Takatsune MORIYAMA, Tokyo (JP)

(21) Appl. No.: 18/870,559

(22) PCT Filed: Jun. 22, 2022
(86) PCT No.: PCT/JP2022/024967

§ 371 Date: Nov. 29, 2024

(51) Int. Cl. H04W 28/02; H04L 41/16; H04W 84/12

(52) U.S. Cl. CPC H04W 28/0236; H04L 41/16; H04W 84/12

(57) ABSTRACT

There is provided a communication quality estimation system including: a learning unit that performs learning of a model which receives wireless environment information as an input and outputs a communication quality, based on a plurality of pieces of data which are recorded each time one or more terminals connect to a certain base station and perform communication and include a set of the wireless environment information and the communication quality of the terminal on which the communication is performed; and an estimation unit that estimates a communication quality in a case where a terminal is connected to a certain base station by inputting, to the model on which learning is performed, the wireless environment information of the terminal for which the certain base station is set as a connection candidate. Thereby, it is possible to estimate a communication quality in a case where connection to a certain base station is established.

### TECHNICAL FIELD

The present invention relates to a communication quality estimation system, a communication quality estimation method, and a program.

### BACKGROUND ART

Public wireless LAN services using a wireless LAN are provided. In a smartphone or the like, in a case where a wireless LAN can be used, the wireless LAN is selected as communication means.

In general, connection to a wireless LAN is performed in a case where reception power of a beacon signal transmitted by a base station (AP) is equal to or higher than a certain level. Further, in a case where a plurality of APs in which the reception power is equal to or higher than a certain level are found, the AP having the highest reception power is selected as a connection destination (Non Patent Literature 1).

In a case where the number of terminals connected to a base station and resource channel utilization are included in a beacon signal of the wireless LAN and the beacon signal is transmitted in advance, the terminal determines whether to receive the beacon signal and perform connection (Non Patent Literature 2, 9.4.2.27, BSS load element).

### CITATION LIST

### Non Patent Literature

Non Patent Literature 1: Maneesha V. Ramesh; M. S. Nisha, “Design of Optimization Algorithm for WLAN AP Selection during Emergency Situations”, 2011 IEEE 3rd International Conference on Communication Software and Networks
Non Patent Literature 2: IEEE wireless LAN specification (IEEE std 802.11-2020)

### SUMMARY OF INVENTION

### Technical Problem

In Non Patent Literature 1, since interference from the surroundings, congestion of the APs, and a bandwidth of an upper network of the AP are unknown, determination is performed only by intensity of radio waves. As a result, a desired quality (a throughput or the like) may not be obtained after connection. In addition, in recent wireless LANs, a throughput improvement technique by signal processing in a physical layer, such as beamforming or MIMO transmission, has also been introduced. In the technique, reception power often does not match the throughput.

In Non Patent Literature 2, in a case where quality information to be transmitted is correct, congestion of the base stations can be recognized before connection. However, it is not possible to directly predict the throughput to be obtained.

The present invention has been made in view of the above points, and an object of the present invention is to estimate a communication quality in a case where a terminal is connected to a certain base station.

### Solution to Problem

Therefore, in order to solve the above problems, there is provided a communication quality estimation system including: a learning unit that performs learning of a model which receives wireless environment information as an input and outputs a communication quality, based on a plurality of pieces of data which are recorded each time one or more terminals connect to a certain base station and perform communication and include a set of the wireless environment information and the communication quality of the terminal on which the communication is performed; and an estimation unit that estimates a communication quality in a case where a terminal is connected to a certain base station by inputting, to the model on which learning is performed, the wireless environment information of the terminal for which the certain base station is set as a connection candidate.

### Advantageous Effects of Invention

It is possible to estimate a communication quality in a case where connection to a certain base station is established.

### BRIEF DESCRIPTION OF DRAWINGS

FIG. 1 is a diagram illustrating a configuration example of a communication quality estimation system according to an embodiment of the present invention.

FIG. 2 is a diagram for explaining an estimator.

FIG. 3 is a diagram illustrating a hardware configuration example of a communication quality estimation server 10 according to the embodiment of the present invention.

FIG. 4 is a diagram illustrating a functional configuration example of the communication quality estimation system according to the embodiment of the present invention.

FIG. 5 is a flowchart for explaining an example of a processing procedure of processing of generating an estimator.

FIG. 6 is a flowchart for explaining an example of a processing procedure of processing of standardizing a feature amount.

FIG. 7 is a flowchart for explaining an example of a processing procedure of learning processing of the estimator.

FIG. 8 is a flowchart for explaining an example of a processing procedure of processing of estimating a communication quality.

### DESCRIPTION OF EMBODIMENTS

In the present embodiment, in order to allow a terminal to detect a communication quality (throughput) obtained in a case where the terminal is connected to a base station (AP) of a wireless local area network (LAN) before connection to the wireless LAN is established and to determine whether to use the wireless LAN, a communication quality is estimated from past records and surrounding wireless environment information by using machine learning, and the estimated value is notified to the terminal.

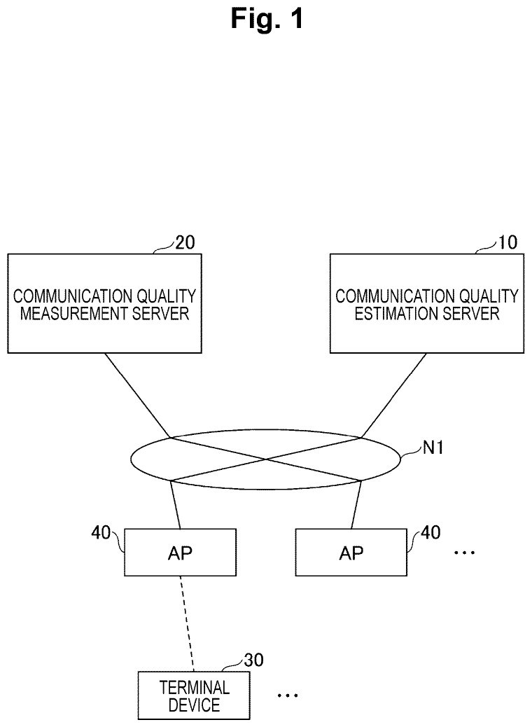

Hereinafter, an embodiment of the present invention will be described with reference to the drawings. FIG. 1 is a diagram illustrating a configuration example of a communication quality estimation system according to the embodiment of the present invention. FIG. 1 illustrates one or more terminal devices 30, a plurality of APs 40, a communication quality estimation server 10, and a communication quality measurement server 20.

The terminal device 30 is a terminal capable of performing communication using a wireless LAN. For example, a smartphone, a tablet terminal, a personal computer (PC), or the like may be used as the terminal device 30.

The AP 40 is a base station of a wireless LAN, and connects the terminal device 30 to a network N1 such as the Internet via the wireless LAN.

The communication quality measurement server 20 is one or more computers that measure a communication quality with the terminal device 30 which is connected to the network N1 via the wireless LAN (that is, connected to the AP 40) and performs communication.

The communication quality estimation server 10 is one or more computers that estimate (predict) a communication quality in a case where the terminal device 30 is connected to any one of the APs 40.

First, the terminal device 30 is connected to any one of the APs 40 to perform communication with the communication quality measurement server 20, and measures a quality (communication quality) of the communication. The terminal device 30 also acquires information (hereinafter, referred to as “wireless environment information”) indicating a wireless environment of the terminal device 30 when measuring the communication quality. The terminal device 30 transmits (uploads), to the communication quality estimation server 10, data (hereinafter, referred to as “observation data”) including a set of the acquired wireless environment information and information indicating the measured communication quality (hereinafter, referred to as “quality information”). The wireless environment information includes, for example, one or more parameters of identification information of the AP 40 (hereinafter, referred to as a “target AP”) to which the terminal device 30 is connected, an available bandwidth of the target AP, the current date and time, a received signal strength indicator (RSSI) of the target AP, a channel usage rate of the target AP, the number of adjacent APs (having the same channel) on the same channel as the target AP, a channel usage rate of each of the adjacent APs, and a RSSI of each of the adjacent APs. In the present embodiment, a case where the wireless environment information includes all these parameters will be described. On the other hand, some parameters may be omitted or other parameters may be added.

Here, the adjacent APs refer to APs 40 which are other than the target AP and from which the terminal device 30 can receive radio waves by scanning adjacent wireless LANs. It does not matter whether or not the adjacent APs have the same channel as the target AP. The number of the adjacent APs and the RSSI of the adjacent AP can be acquired by scanning. In addition, the channel usage rate of the adjacent AP can be acquired from a beacon signal or a probe response signal of the adjacent AP.

Further, the quality information is, for example, information including values and the like of parameters (hereinafter, referred to as “quality parameters”) such as a throughput (uplink, downlink), a delay, a jitter, and a packet loss in a result of communication. Regarding the quality information, some parameters may be omitted, or other parameters may be added.

The communication quality estimation server 10 stores the received observation data in a database. Note that the wireless environment information includes identification information of the target AP. The communication quality estimation server 10 stores a plurality of pieces of observation data, which are uploaded from a plurality of terminal devices 30, in the database.

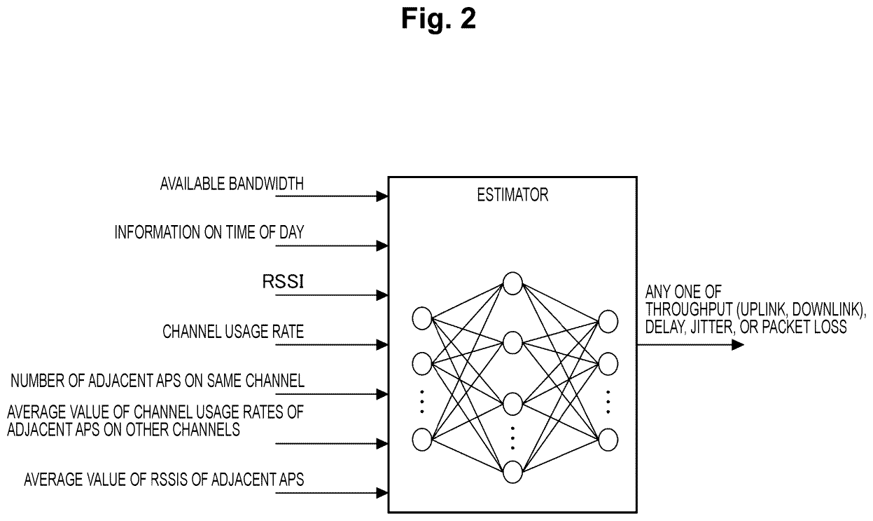

Thereafter, the communication quality estimation server 10 extracts the observation data from the database in units of base stations, and generates an estimator for each base station and each quality parameter by machine learning such as a neural network. As illustrated in FIG. 2, the estimator is a model (a neural network or the like) that receives a feature amount of the wireless environment information as an input and outputs an estimated value of a communication quality. The feature amount of the wireless environment information is a parameter group that is input to the estimator in FIG. 2. That is, the feature amount includes the available bandwidth of the AP 40 (target AP) to which the terminal device 30 is connected, information on the time of day, the RSSI of the target AP, the channel usage rate of the target AP, the number of adjacent APs on the same channel as the channel of the target AP, an average value of the channel usage rates of the adjacent APs on other channels (channels different from the channel of the target AP), and an average value of the RSSIs of the adjacent APs, which can be easily derived from the wireless environment information. Since the estimator is generated for each base station and each quality parameter, one estimator outputs (estimates) any one of a throughput (uplink, downlink), a delay, a jitter, or a packet loss.

In a case where a connectable AP 40 (hereinafter, referred to as a “candidate AP”) is found, the terminal device 30 inquires an estimated value of the communication quality (hereinafter, referred to as “estimated quality”) by transmitting the wireless environment information of the terminal device 30 at that time to the communication quality estimation server 10 via a network (a network different from the wireless LAN (for example, a mobile communication network or the like)). The communication quality estimation server 10 estimates a communication quality by inputting the feature amount of the wireless environment information to the estimator corresponding to the AP 40, and transmits the estimated quality to the terminal device 30.

In a case where the estimated quality is received, the terminal device 30 can determine whether or not to connect to the candidate AP based on, for example, whether or not a desired communication quality can be obtained.

Note that the communication quality measurement server 20 and the communication quality estimation server 10 may be implemented using different computers or may be implemented using the same computer. In a case where the communication quality measurement server 20 and the communication quality estimation server 10 are implemented using different computers, installation locations on the network N1 may be different.

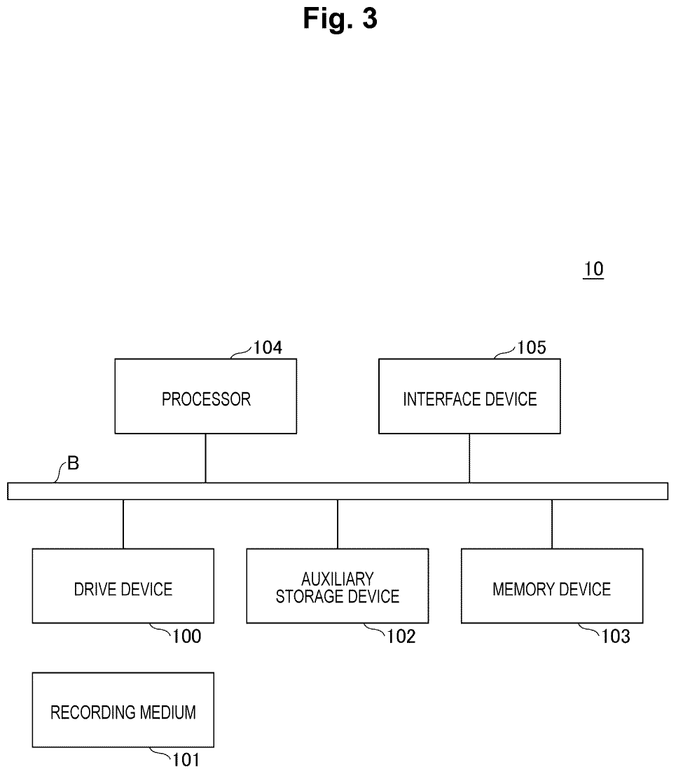

FIG. 3 is a diagram illustrating a hardware configuration example of the communication quality estimation server 10 according to the embodiment of the present invention. The communication quality estimation server 10 in FIG. 3 includes a drive device 100, an auxiliary storage device 102, a memory device 103, a processor 104, an interface device 105, and the like, which are connected to each other via a bus B.

A program for implementing processing in the communication quality estimation server 10 is provided by a recording medium 101 such as a CD-ROM. When the recording medium 101 storing the program is set in the drive device 100, the program is installed from the recording medium 101 to the auxiliary storage device 102 via the drive device 100. Here, the program is not necessarily installed from the recording medium 101, and may be downloaded from another computer via a network. The auxiliary storage device 102 stores the installed program, and also stores, for example, necessary files and data.

In a case where an instruction is issued to start the program, the memory device 103 reads the program from the auxiliary storage device 102 and stores the program. The processor 104 is a CPU or a graphics processing unit (GPU), or a CPU and a GPU, and executes a function related to the communication quality estimation server 10 according to the program stored in the memory device 103. The interface device 105 is used as an interface for connection to a network.

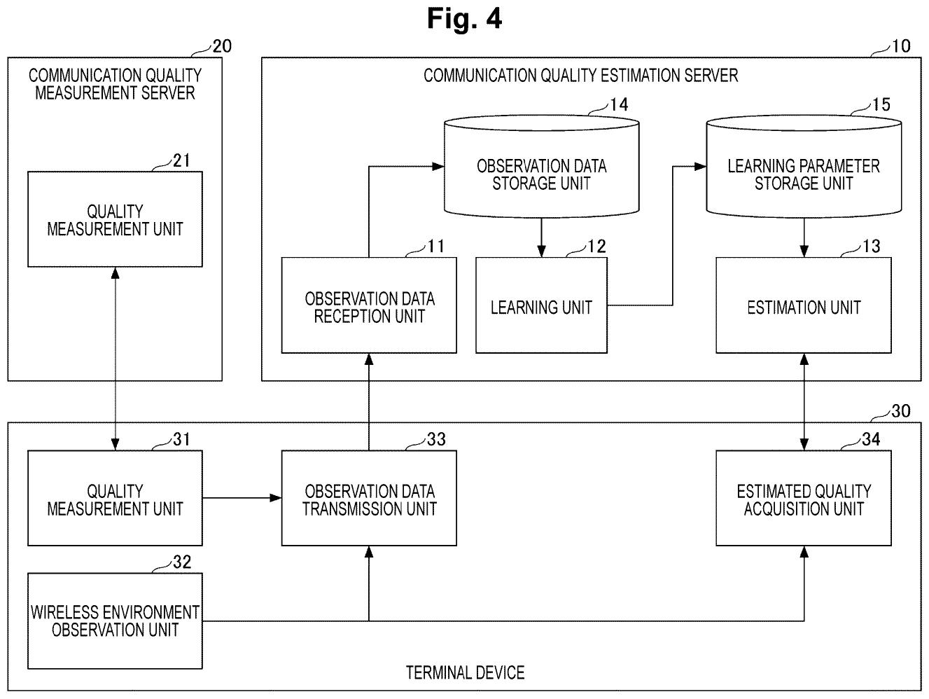

FIG. 4 is a diagram illustrating a functional configuration example of the communication quality estimation system according to the embodiment of the present invention.

In FIG. 4, the communication quality measurement server 20 includes a quality measurement unit 21. The quality measurement unit 21 is implemented by processing executed by a processor (the processor 104 in a case where the communication quality measurement server 20 is implemented by using the same computer as the communication quality estimation server 10) of the communication quality measurement server 20 according to one or more programs installed in the communication quality measurement server 20.

The communication quality estimation server 10 includes an observation data reception unit 11, a learning unit 12, and an estimation unit 13. These units are implemented by processing executed by the processor 104 according to one or more programs installed in the communication quality estimation server 10. The communication quality estimation server 10 also uses an observation data storage unit 14 and a learning parameter storage unit 15. Each of these storage units can be implemented by using, for example, the auxiliary storage device 102 or a storage device connectable to the communication quality estimation server 10 via a network.

The terminal device 30 includes a quality measurement unit 31, a wireless environment observation unit 32, an observation data transmission unit 33, and an estimated quality acquisition unit 34. Each of these units is implemented by processing executed by the processor of the terminal device 30 according to one or more programs installed in the terminal device 30.

The quality measurement unit 31 of the terminal device 30 is connected to any one of the APs 40 to perform communication with the communication quality measurement server 20, and acquires quality information by measuring a quality (communication quality) of the communication with the quality measurement unit 21.

The wireless environment observation unit 32 acquires wireless environment information when measuring the communication quality by the quality measurement unit 31 or wireless environment information when inquiring of the communication quality estimation server 10 about the estimated quality.

The observation data transmission unit 33 transmits, to the communication quality estimation server 10, observation data including the quality information acquired by the quality measurement unit 31 and the wireless environment information acquired by the wireless environment observation unit 32 when measuring the communication quality.

The observation data reception unit 11 of the communication quality estimation server 10 receives the observation data, and records the observation data in the observation data storage unit 14. Therefore, the observation data is recorded in the observation data storage unit 14 each time the communication quality is measured by each terminal device 30.

The learning unit 12 performs learning on the estimator for each AP 40 and each quality parameter by using the observation data group recorded in the observation data storage unit 14, and records a learning result (a value of the learning parameter of the estimator) in the learning parameter storage unit 15.

The estimated quality acquisition unit 34 of the terminal device 30 inquires of the communication quality estimation server 10 about the estimated quality of the connection candidate AP 40 (target AP), for example, at a timing before connection to the wireless LAN is established. At this time, the estimated quality acquisition unit 34 transmits the wireless environment information of the terminal device 30 that is acquired by the wireless environment observation unit 32 at the timing to the communication quality estimation server 10.

In response to the inquiry from the estimated quality acquisition unit 34, the estimation unit 13 of the communication quality estimation server 10 estimates a communication quality corresponding to the wireless environment information by inputting, to the estimator corresponding to the target AP, the wireless environment information transmitted from the estimated quality acquisition unit 34 according to the inquiry. The estimation unit 13 transmits, to the estimated quality acquisition unit 34 as a source of the inquiry, the estimated value (estimated quality) of the communication quality that is output by the estimator.

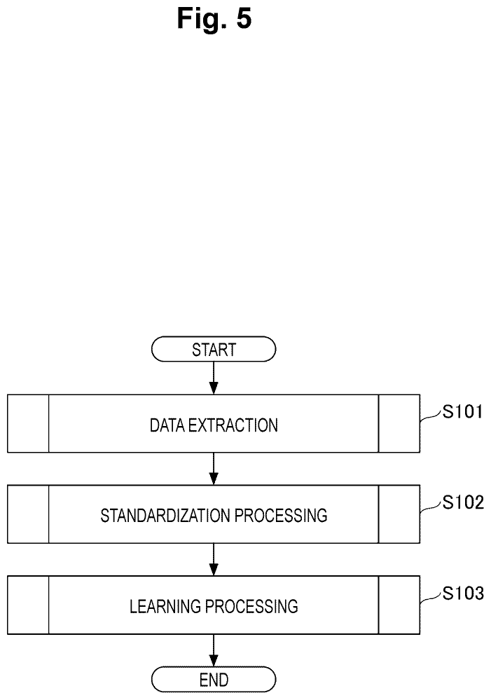

Hereinafter, a processing procedure executed by the communication quality estimation server 10 will be described. FIG. 5 is a flowchart for explaining an example of a processing procedure of processing of generating the estimator. The processing procedure of FIG. 5 is executed at a periodic timing or a plurality of timings according to a predetermined event (for example, an operation or the like by an administrator of the communication quality estimation server 10).

In step S101, the learning unit 12 extracts a learning data group for each AP 40 and each quality parameter from a set of a plurality of pieces of observation data (a set of the wireless environment information and the communication quality information), which are stored in the observation data storage unit 14, in a period (hereinafter, referred to as a “target period”) from a timing of previous learning (a timing to start collection of the observation data in a case where learning is performed for the first time) to the current time point. At this time, the learning unit 12 extracts a feature amount from the wireless environment information. For example, in a case where the number of the APs 40 is n and the number of the quality parameters is m, (n×m) learning data groups (hereinafter, referred to as “learning data sets”) are extracted. The learning data set corresponding to a certain AP 40 and a certain quality parameter is a set of pieces of learning data, which include a set of the feature amount of the wireless environment information including the identification information of the AP 40 and the quality parameter associated with the wireless environment information.

Subsequently, the learning unit 12 standardizes each feature amount of each of the pieces of learning data for each learning data set (that is, for each AP 40 and each quality parameter) (S102). The feature amount includes, as described above, the available bandwidth of the target AP, information on the time of day, the RSSI of the target AP, the channel usage rate of the target AP, the number of adjacent APs on the same channel as the channel of the target AP, an average value of the channel usage rates of the adjacent APs on other channels (channels different from the channel of the target AP), and an average value of the RSSIs of the adjacent APs.

Subsequently, the learning unit 12 executes learning processing of the estimator for each learning data set (that is, for each AP 40 and each quality parameter) (S103).

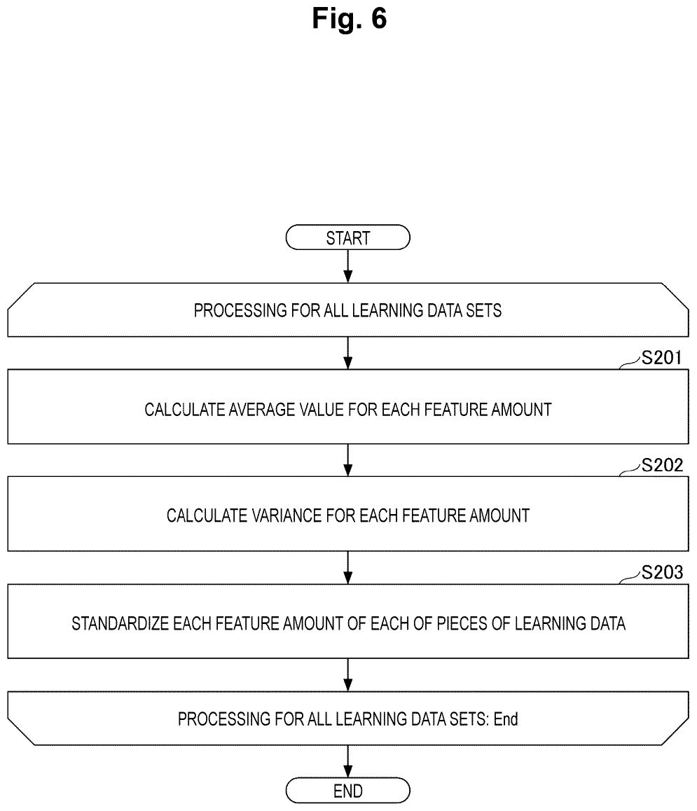

Subsequently, details of step S102 will be described. FIG. 6 is a flowchart for explaining an example of a processing procedure of processing of standardizing the feature amount. In FIG. 6, processing of step S201 to step S203 is executed for each learning data set. Hereinafter, the learning data set to be processed is referred to as a “target learning data set”.

In step S201, the learning unit 12 calculates an average value μ (average value for each feature amount) of the target learning data set for each feature amount. The average value μ of a certain feature amount can be calculated based on the following expression.

$$μ = \frac{1}{N} {\sum }_{i}^{N} {x}_{i} \qquad [ Math . 1 ]$$

Here, N is the total number of pieces of learning data included in the target learning data set. xᵢ is a value of the feature amount of the i-th learning data in the target learning data.

Subsequently, the learning unit 12 calculates a variance σ² (variance for each feature amount) of the target learning data set for each feature amount. The variance σ² of a certain feature amount can be calculated based on the following expression.

$${σ}^{2} = \frac{1}{N} {\sum }_{i}^{N} {( {x}_{i} - μ )}^{2} \qquad [ Math . 2 ]$$

Subsequently, the learning unit 12 standardizes each feature amount of each of the pieces of learning data included in the target learning data set (S203). A certain feature amount can be standardized based on the following expression.

$$\tilde{{x}_{i}} = \frac{{x}_{i} - μ}{σ} \qquad [ Math . 3 ]$$

The learning unit 12 updates the feature amount of each of the pieces of learning data to a standardized value.

In a case where processing of step S201 to step S203 is executed for all the learning data sets, the processing procedure of FIG. 6 is ended.

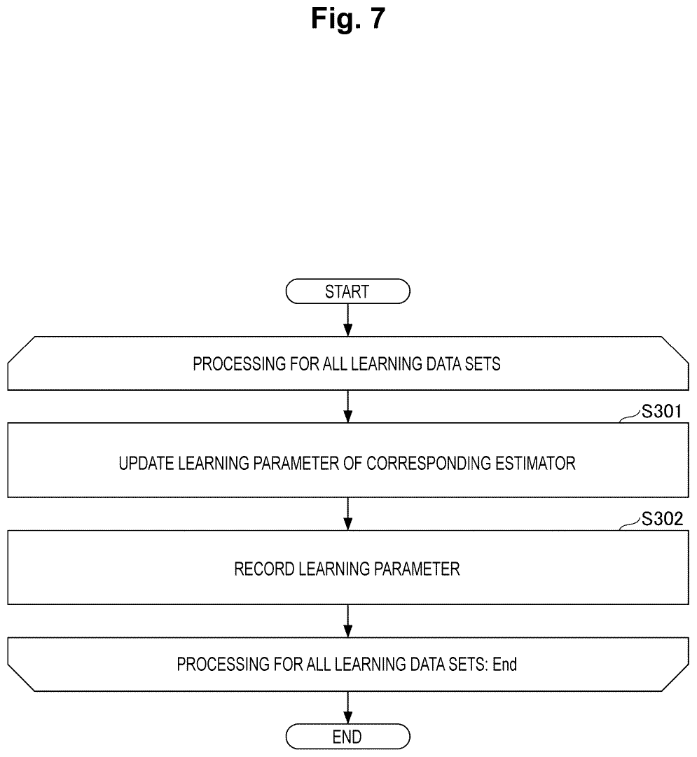

Next, details of step S103 in FIG. 5 will be described. FIG. 7 is a flowchart for explaining an example of a processing procedure of learning processing of the estimator. In FIG. 7, processing of step S301 and step S302 is executed for each learning data set. Hereinafter, the learning data set to be processed is referred to as a “target learning data set”. Further, the estimator corresponding to the target learning data set is referred to as a “target estimator”.

In step S301, the learning unit 12 inputs the feature amount included in the learning data to the target estimator for each of the pieces of learning data included in the target learning data set, and updates the learning parameter of the target estimator such that a loss between the estimated quality which is output by the estimator and the value of the quality parameter included in the learning data is reduced. Note that, in a case where learning is performed on the target estimator in the past, the learning unit 12 sets, in the target estimator, as an initial value for the target estimator, the value of the learning parameter which stored in the learning parameter storage unit 15, and then executes processing of step S301.

Subsequently, the learning unit 12 records, in the learning parameter storage unit 15, the value of the learning parameter of the target estimator on which learning is performed in association with the identification information of the AP 40 and the identification information of the quality parameter, which correspond to the target learning data (S302).

In a case where processing of step S301 and step S302 is executed for all the learning data sets, the processing procedure of FIG. 7 is ended.

Next, processing of estimating a communication quality using the estimator on which learning is performed will be described.

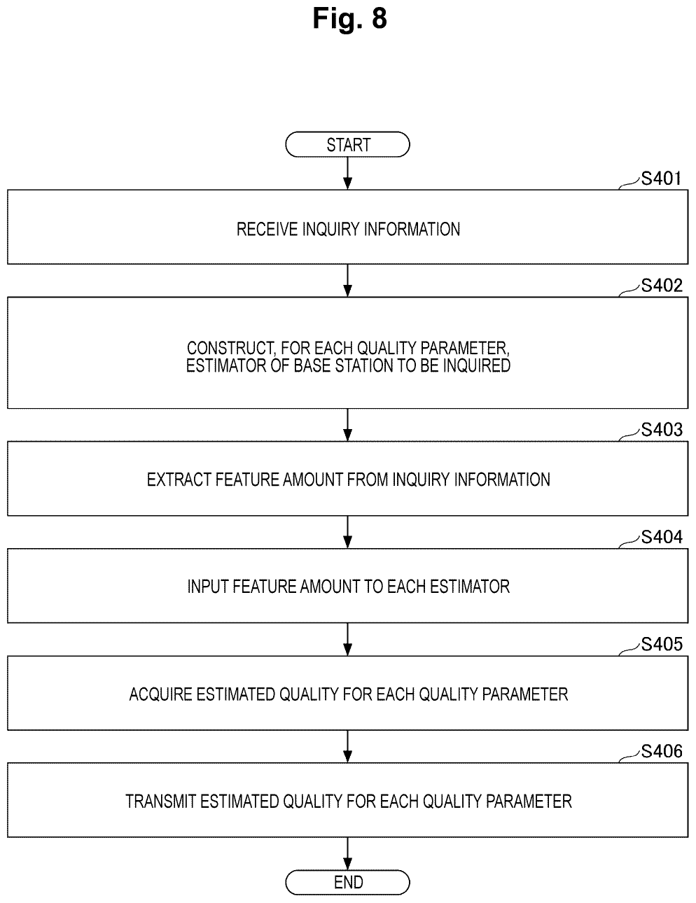

FIG. 8 is a flowchart for explaining an example of a processing procedure of processing of estimating a communication quality.

In a case where a certain terminal device 30 transmits information (hereinafter, referred to as “inquiry information”) indicating an inquiry about the estimated quality of the connection candidate AP 40 (hereinafter, referred to as a “candidate AP”) to the communication quality estimation server 10, the estimation unit 13 receives the inquiry information (S401). The inquiry information includes wireless environment information related to the candidate AP. The wireless environment information related to the candidate AP includes the identification information of the candidate AP, the available bandwidth of the candidate AP, the current date and time, the RSSI of the candidate AP, the channel usage rate of the candidate AP, the number of adjacent APs on the same channel as the channel of the candidate AP, the channel usage rate of each adjacent AP, and the RSSI of each adjacent AP.

Subsequently, the estimation unit 13 constructs, for each candidate AP and each quality parameter, an estimator on which learning is performed by setting, to a model as an estimator, the values of the learning parameters that are related to the candidate AP and the quality parameter and are stored in the learning parameter storage unit 15 (S402). Therefore, estimators for the number of the quality parameters are constructed.

Subsequently, the estimation unit 13 extracts a feature amount from the wireless environment information included in the inquiry information (S403). The feature amount includes the available bandwidth of the candidate AP, information on the time of day, the RSSI of the candidate AP, the channel usage rate of the candidate AP, the number of adjacent APs on the same channel as the channel of the candidate AP, an average value of the channel usage rates of the adjacent APs on other channels (channels different from the channel of the candidate AP), and an average value of the RSSIs of the adjacent APs.

Subsequently, the estimation unit 13 inputs each feature amount extracted in step S403 to each estimator for each quality parameter (S404).

Subsequently, the estimation unit 13 acquires each value which is output by each estimator as an estimated value (estimated quality) of the quality parameter corresponding to the estimator (S405).

Subsequently, the estimation unit 13 transmits the estimated quality for each quality parameter related to the candidate AP to the terminal device 30 as a source of the inquiry (S406).

As described above, according to the present embodiment, it is possible to estimate a communication quality in a case where connection to a certain base station is established. In view of the feature amount used at this time, it is possible to estimate a quality in consideration of a change in network congestion depending on the time of day and an influence of interference from the adjacent APs 40.

Although the embodiment of the present invention has been described in detail above, the present invention is not limited to such a specific embodiment, and various modifications and alterations can be made without departing from the scope of the present invention described in the accompanying claims.

### REFERENCE SIGNS LIST

10 Communication quality estimation server
11 Observation data reception unit
12 Learning unit
13 Estimation unit
14 Observation data storage unit
15 Learning parameter storage unit
20 Communication quality measurement server
21 Quality measurement unit
30 Terminal device
31 Quality measurement unit
32 Wireless environment observation unit
33 Observation data transmission unit
34 Estimated quality acquisition unit
40 AP
100 Drive device
101 Recording medium
102 Auxiliary storage device
103 Memory device
104 Processor
105 Interface device
B Bus

1. A communication quality estimation system comprising:
a processor; and
a memory storing program instructions that cause the processor to:
perform learning of a model which receives wireless environment information as an input and outputs a communication quality, based on a plurality of pieces of data which are recorded each time one or more terminals connect to a certain base station and perform communication and include a set of the wireless environment information and the communication quality of the terminal on which the communication is performed; and
estimate a communication quality in a case where a terminal is connected to a certain base station by inputting, to the model on which learning is performed, the wireless environment information of the terminal for which the certain base station is set as a connection candidate.

2. The communication quality estimation system according to claim 1, wherein
the program instructions cause the processor to perform learning of the model for each of a plurality of base stations, based on the plurality of pieces of data which are recorded each time one or more terminals connect to a base station and perform communication and include a set of the wireless environment information and the communication quality of the terminal when the communication is performed, and
estimate a communication quality in a case where a certain terminal is connected to a base station by inputting the wireless environment information of the terminal to the model on which learning is performed and which corresponds to the base station as a connection candidate of the certain terminal.

3. The communication quality estimation system according to claim 1, wherein
the wireless environment information of the terminal includes any one of an available bandwidth of a first base station to which the terminal is connected, the current date and time, an RSSI of the first base station, a channel usage rate of the first base station, the number of second base stations which are on the same channel as the channel of the first base station and from which the terminal can receive radio waves, a channel usage rate of each of the second base stations, or the second base station.

4. A communication quality estimation method causing a computer to execute a process comprising:
performing learning of a model which receives wireless environment information as an input and outputs a communication quality, based on a plurality of pieces of data which are recorded each time one or more terminals connect to a certain base station and perform communication and include a set of the wireless environment information and the communication quality of the terminal on which the communication is performed; and
estimating a communication quality in a case where a terminal is connected to a certain base station by inputting, to the model on which learning is performed, the wireless environment information of the terminal for which the certain base station is set as a connection candidate.

5. A non-transitory computer-readable recording medium having stored therein a program causing a computer to perform the communication quality estimation method according to claim 4.
